(19) United States
(12) Patent Application Publication
(10) Pub. No.: US 2011/0291312 A1
(43) Pub. Date: Dec. 1, 2011

(54) EXTRUSION DIE

(75) Inventors: Hidekazu Sakihama, Oyama-shi (JP); Kouichi Tanaka, Oyama-shi (JP)

(73) Assignee: SHOWA DENKO K.K., Minato-ku, Tokyo (JP)

(21) Appl. No.: 13/143,246

(22) PCT Filed: Dec. 28, 2009
(86) PCT No.: PCT/JP2009/071795

§ 371 Date: Aug. 18, 2011

(30) Foreign Application Priority Data
Jan. 6, 2009 (JP) 2009-000739

(51) Int. Cl. B29C 47/20

(52) U.S. Cl. 264/39; 425/461

(57) ABSTRACT

In an extrusion die in which a mandrel ring is outwardly arranged around a spindle, the present invention aims to enhance the fixing stability of the mandrel ring and enables easy maintenance. The extrusion die includes a mandrel (30) for forming an inner surface of an extruded material. The mandrel includes a spindle (32) and a mandrel ring (35) outwardly arranged around the spindle (32). The mandrel ring (35) is made of a material having a coefficient of thermal expansion smaller than that of a material of the spindle (32). In a state in which the mandrel ring (35) is outwardly arranged around the spindle (32), the extrusion die is configured such that a gap is formed between an outer circumferential surface (32a) of the spindle (32) and an inner circumferential surface (35a) of the mandrel ring (35) at a normal temperature and the gap disappears at least partially in an axial direction of the mandrel (30) to allow contact of both the outer circumferential surface of the spindle (32) and the inner circumferential surface of the mandrel ring (35) at a die temperature at the time of extrusion.

### TECHNICAL FIELD

The present invention relates to an extrusion die for use in extruding a hollow member.

In this specification and claims, a direction in which an extruded member or an extruding material is advanced will be referred to as a direction toward a downstream side, while the opposite direction will be referred to as a direction toward an upstream side.

### TECHNICAL BACKGROUND

In an extrusion die, for the purpose of giving abrasion resistance to a bearing portion of a die, a hard material, such as, e.g., sintered hard alloy or ceramic, is used as a material constituting a portion of the die including the bearing portion (See Patent Documents 1 to 3).

Patent Document 1 discloses a die in which a ring-shaped die made of a hard material is shrink-fitted in a concave portion of a die case made of a tool steel. Patent Document 2 discloses a male die for a porthole die. This male die is configured such that a spindle of a mandrel is made of a tool steel, a mandrel ring made of a hard material is outwardly fitted on the spindle, and the mandrel ring is fixed to the spindle with a pull-out-prevention nut screwed onto the tip end of the spindle. Patent Document 3 discloses a die in which a sleeve made of material softer than a spindle is arranged between the spindle and a mandrel ring and the mandrel ring is shrink-fitted on the spindle.

### PRIOR ART DOCUMENTS

### Prior Arts

[Patent Document 1] Japanese Unexamined Laid-open Patent Publication No. H06-15348
[Patent Document 2] Japanese Unexamined Laid-open Patent Publication No. 2003-181525
[Patent Document 3] Japanese Examined Laid-open Patent Publication No. H04-69009

### SUMMARY OF THE INVENTION

### Problems to be Solved by the Invention

In such a hard metal shrink-fitted type die, however, there are such problems that it requires time-consuming preparation and/or maintenance.

A hard material has characteristics that it is smaller in coefficient of thermal expansion than a tool steel and weaker in tensile strength than a tool steel. For this reason, in the case where a mandrel ring of a hard material is outwardly fitted on a spindle of a tool steel, the spindle expands during the hot extrusion process, which may cause breakage of the mandrel ring if the tightening force to the mandrel ring is excessive. On the other hand, if the tightening force is insufficient, the mandrel ring is not firmly fixed to the spindle, which may cause waves on the extruded joint and/or uneven thickness of the extruded material. Further, the mandrel ring may be detached from the spindle due to the flow of the extrusion material.

Furthermore, it is desired to maintain dimensions and strength of a mandrel ring for a long period of time and extend the die life.

### Means for Solving the Problems

The present invention was made in view of the aforementioned technical background, and aims to provide an extrusion die having a mandrel ring outwardly arranged around a spindle, which is capable of stably fixing a mandrel ring and easily performing maintenance, and has a long die life.

The present invention has the structure recited in [1] to [15].

[1] An extrusion die comprising:

a mandrel for forming an inner surface of an extruded material,

wherein the mandrel includes a spindle and a mandrel ring outwardly arranged around the spindle,

wherein the mandrel ring is made of a material having a coefficient of thermal expansion smaller than that of a material of the spindle, and

wherein, in a state in which the mandrel ring is outwardly arranged around the spindle, the extrusion die is configured such that a gap is formed between an outer circumferential surface of the spindle and an inner circumferential surface of the mandrel ring at anormal temperature and the gap disappears at leastpartially in an axial direction of the mandrel to allow contact of both the outer circumferential surface of the spindle and the inner circumferential surface of the mandrel ring at a die temperature at the time of extrusion.

[2] The extrusion die as recited in Item 1, wherein an outer diameter A_{T1} of the spindle and an inner diameter B_{T1} of the mandrel ring at the normal temperature (T₁) are set so that a tightening degree (X_{T2}) between the spindle and the mandrel ring at the die temperature (T₂) at the time of extrusion at a portion where the gap at the normal temperature (T₁) is minimum is 0 to 0.3%,

wherein the tightening degree (X_{T2}) is represented by an equation of:

X_{T2}[A_{T1}×(T₂−T₁)×α₁+A_{T1}]/[B_{T1}×(T₂−T₁)×B_{T1}]−1}×100

where

α₁: coefficient of thermal expansion of the material constituting the spindle,

α₂: coefficient of thermal expansion of the material constituting the base material of the mandrel ring (α₁>α₂),

T₁: normal temperature,

T₂: die temperature (>T₁) at the time of extrusion,

A_{T1} outer circumference diameter of the spindle at the normal temperature T₁, and

B_{T1}: inner circumference diameter (>A_{T1}) of the mandrel ring at the normal temperature T₁.

[3] The extrusion die as recited in Item 1 or 2, wherein a restraining member configured to prevent detachment of the mandrel ring is detacheably attached to a tip end of the spindle.

[4] The extrusion die as recited in any one of Items 1 to 3, wherein the spindle is non-circular in cross-section.

[5] The extrusion die as recited in any one of Items 1 to 4, wherein the spindle is solid.

[6] The extrusion die as recited in any one of Items 1 to 5, wherein the mandrel ring is made of hard material,

[7] The extrusion die as recited in Item 6, wherein the mandrel ring is made of ceramic material.

[8] The extrusion die as recited in any one of Items 1 to 7, wherein the mandrel ring includes a relief portion on at least one of an upstream side and a downstream side of a bearing portion.

[9] The extrusion die as recited in Item 8, wherein the mandrel ring includes a bearing portion formed at a downstream side than a center of the mandrel ring in an axial direction thereof.

[10] The extrusion die as recited in any of Items 1 to 7, wherein the mandrel ring includes a bearing portion formed along an entire region of the mandrel ring in an axial direction thereof.

[11] The extrusion die as recited in any of Items 1 to 10, wherein the mandrel ring includes a hard alkali-resistant coating formed at least on an outer circumference of a base material of the mandrel ring.

[12] The extrusion die as recited in Item 11, wherein the mandrel ring includes an alkali-resistant coating formed only on an outer circumference and an inner circumference of the base material of the mandrel ring.

[13] An extrusion method comprising:

preparing an extrusion die comprising a mandrel for forming an inner surface of an extruded material, wherein the mandrel includes a spindle and a mandrel ring outwardly arranged around the spindle, and the mandrel ring is made of a material having a coefficient of thermal expansion smaller than that of a material of the spindle; and

executing extrusion using the extrusion die at a die temperature (T₂) at which a tightening degree (X_{T2}) between the spindle and the mandrel ring becomes 0 to 0.3% at a portion where a gap between an outer circumferential surface of the spindle and an inner circumferential surface of the mandrel ring is minimum at a normal temperature (T₁),

wherein the tightening degree (X_{T2}) is represented by an equation of:

X_{T2}={[A_{T1}×(T₂−T₁)×α₁+A_{T1}]/[B_{T1}×(T₂−T₁)×α₂+B_{T1}−1}×100

where

α₁ coefficient of thermal expansion of the material constituting the spindle,

α₂: coefficient of thermal expansion of the material constituting the base material of the mandrel ring (α₁>α₂),

T₁: normal temperature,

T2: die temperature (>T1) at the time of extrusion,

A_{T1}: outer circumference diameter of the spindle at the normal temperature T₁, and

B_{T1}: inner circumference diameter (>A_{T1}) of the mandrel ring at the normal temperature T₁.

[14] The extrusion method as recited in Item 13, wherein the mandrel ring of the extrusion die is provided with a hard alkali-resistant coating at least on an outer circumferential surface of the base material, and wherein alkali cleaning is executed at the time of die maintenance after the extrusion.

[15] A production method of an extruded material, comprising:

preparing an extrusion die including a mandrel for forming an inner surface of an extruded material, wherein the mandrel includes a spindle and a mandrel ring outwardly arranged around the spindle, and the mandrel ring is made of a material having a coefficient of thermal expansion smaller than that of a material of the spindle; and

executing extrusion using the extrusion die at a die temperature (T,) at which a tightening degree (X_{T2}) between the spindle and the mandrel ring becomes 0 to 0.3% at a portion where a gap between an outer circumferential surface of the spindle and an inner circumferential surface of the mandrel ring is minimum at a normal temperature (T₁),

wherein the tightening degree (X_{T2}) is represented by an equation of:

X_{T2}={[A_{T1}×(T₂−T₁)×α₁+A_{T1}]/[B_{T1}×(T₂−T₁)×α₂+B_{T1}]−1)×100

where

α₁: coefficient of thermal expansion of the material constituting the spindle,

α₂: coefficient of thermal expansion of the material constituting the base material of the mandrel ring (α₁>α₂),

T₁: normal temperature,

T₂: die temperature (>T1) at the time of extrusion,

A_{T1}: outer circumference diameter of the spindle at the normal temperature T₁, and

B_{T1}: inner circumference diameter (>A_{T1}) of the mandrel ring at the normal temperature T₁.

### EFFECTS OF THE INVENTION

According to the invention [1], in the mandrel in which the mandrel ring is outwardly arranged around the spindle, when the die reaches an extrusion temperature, the gap between the spindle and the mandrel ring disappears due to the difference of the coefficients of thermal expansion, and the mandrel ring is tightened by the force of the spindle expanding in the radial direction and fixed to the spindle. When extrusion is executed in a state in which the mandrel ring is fixed to the spindle, the uneven thickness of the extruded material is controlled and high quality extruded material can be produced. Also, since there is a gap between the spindle and the mandrel ring at a normal temperature, attachment and detachment of the mandrel ring to and from the spindle can be easily performed, and the maintenance such as exchanging of the mandrel ring can easily be executed.

According to the invention [2], the tightening degree (X_{T2}) between the spindle and the mandrel ring at the die temperature at the time of extrusion is set to fall within an appropriate range, resulting in a stably fixed state, which prevents breakage of the mandrel ring.

According to the invention [3], the mandrel ring is fixed also in the extrusion axial direction by the restraining member, preventing detachment of the mandrel ring, which in turn results in a stably fixed state. Also, by preventing the movement in the extrusion axial direction by the restraining member, the tightening degree (X_{T2}) can be decreased as compared with the case in which only the expansion force of the spindle is used for fixing. This enables to avoid the risk of the possible breakage of the mandrel ring due to the increased tightening degree (X_{T2}).

According to the invention [4], the movements of the mandrel ring in the circumferential direction can be prevented. The prevention of the movements of the mandrel ring in the circumferential direction enhances the fixing stability of the mandrel ring, and also enables positioning of the mandrel ring.

According to the invention [5], the strength of the mandrel is high since the spindle is solid.

According to the inventions [6] and [7], an extrusion die with excellent abrasion resistance can be provided.

According to the invention [8], the strength of the mandrel ring can be secured by forming a relief portion on the mandrel ring.

According to the invention [9], the manufacturing cost of the mandrel ring can be reduced by not forming a relief portion on the mandrel ring.

According to the invention [10], the amount of protrusion of the mandrel into the relief hole of the female die can be reduced, which can reduce the possible contact of the mandrel to the bearing portion of the female die at the time of assembling or dismantling them.

According to the invention [11], the base material of the mandrel ring is protected by forming a hard alkali-resistant coating on at least the outer circumferential surface. This prevents abrasion of the base material by the extruding material during extrusion, and also prevents dissolution of components in the base material surface due to alkali cleaning during the maintenance of the die after extrusion. Furthermore, the abrasion resistance of the alkali-resistant coating prevents the abrasion of the coating itself due to extrusion, which in turn can maintain the dissolution prevention effects for a long period of time. Also, it is possible to re-form an alkali-resistant coating on the mandrel ring removed from the spindle. Therefore, both the protective effects of the base material by the alkali-resistant coating and the possible re-forming of the alkali-resistant coating can maintain the strength of the mandrel ring for a long period of time to extend its life.

According to the invention [12], an alkali-resistant coating is formed on the inner circumferential surface of the mandrel ring in addition to the outer circumferential surface to which the extrusion material adheres. Therefore, during the die cleaning after the extrusion, even if the cleaning solution is entered into the gap formed between the mandrel ring and the spindle, the inner circumferential surface of the base material is protected by the alkali-resistant coating, and the dissolution of the inner circumferential surface due to the cleaning solution can be prevented and changes of the inner diameter of the mandrel ring can be prevented. The maintaining of the inner radius of the mandrel ring secures the fixed stability of the mandrel ring in the radial direction. Furthermore, because the alkali-resistant coating is not formed on the end face of the mandrel ring, the cost of surface treatment can be reduced.

According to the invention [13], since the extrusion is executed in a state in which the mandrel ring is fixed to the spindle, the uneven thickness of the extruded material can be controlled.

According to the invention [14], since the base material of the mandrel ring is protected by a hard alkali-resistant coating, abrasion of the base material by the extruding material during extrusion is prevented, and during the die maintenance after extrusion, the dissolution of components in the base material surface due to alkali cleaning can be prevented to thereby prevent abrasion of the base material, which enables manufacturing of a high quality extruded material for a long period of time.

According to the invention [15], since extrusion is executed in a state in which the mandrel ring is fixed to the spindle, a high quality extruded material with a controlled uneven thickness can be produced.

### BRIEF DESCRIPTION OF THE DRAWINGS

FIG. 1 is an exploded perspective view of a porthole die having a male die according to an embodiment of the present invention.

FIG. 2 is across-sectional view showing an assembled state of the porthole die shown in FIG. 1.

FIG. 3 is a cross-sectional view showing a disassemble state of the mandrel of the porthole die shown in FIG. 1.

FIG. 4 is a graph showing a relationship between temperatures and outer diameters of the spindle and inner diameters of the mandrel ring.

FIG. 5A is a cross-sectional view showing the mandrel shown in FIG. 3 in a normal temperature state.

FIG. 5B is a cross-sectional view showing the mandrel shown in FIG. 3 in a die temperature state at the time of extrusion.

FIG. 5C is another cross-sectional view showing the mandrel shown in FIG. 3 in a normal temperature state.

FIG. 6A is an explanatory cross-sectional view showing the restraining of the mandrel ring by the nut at a normal temperature in the mandrel shown in FIG. 3.

FIG. 6B is a cross-sectional view showing a state corresponding to FIG. 6A at a die temperature at the time of extrusion.

FIG. 7A is an explanatory cross-sectional view showing the restraining of the mandrel ring by the nut at a normal temperature in the mandrel shown in FIG. 3.

FIG. 7B is a cross-sectional view showing a state corresponding to FIG. 7A at a die temperature at the time of extrusion.

FIG. 8A is a cross-sectional view showing a shape of a mandrel ring positioned in the circumferential direction.

FIG. 8B is a cross-sectional view showing another shape of a mandrel ring postioned in the circumferential direction.

FIG. 8C is a cross-sectional view showing still another shape of a mandrel ring positioned in the circumferential direction.

FIG. 9A is a cross-sectional view showing another shape of a bearing portion of a mandrel ring.

FIG. 9B is a cross-sectional view showing still other shape of a bearing portion of a mandrel ring.

FIG. 9C is a cross-sectional view showing still yet other shape of a bearing portion of a mandrel ring.

FIG. 9D is a cross-sectional view showing still yet other shape of a bearing portion of a mandrel ring.

FIG. 10A is a cross-sectional view showing an example of forming an alkali-resistant coating of a mandrel ring.

FIG. 10B is a cross-sectional view showing another example of forming an alkali-resistant coating of a mandrel ring.

FIG. 10C is a cross-sectional view showing still other example of forming an alkali-resistant coating of a mandrel ring.

FIG. 10D is a cross-sectional view showing still yet other example of forming an alkali-resistant coating of a mandrel ring.

FIG. 10E is a cross-sectional view showing other mandrel using the mandrel ring shown in FIG. 10B.

FIG. 11 is a cross-sectional view showing a mandrel using a mandrel ring in which an alkali-resistant coating is formed only on an outer circumferential surface of a base material.

FIG. 12 is a schematic cross-sectional view showing dimensions of a spindle and a mandrel ring used in an embodiment.

### BEST MODE FOR CARRYING OUT THE INVENTION

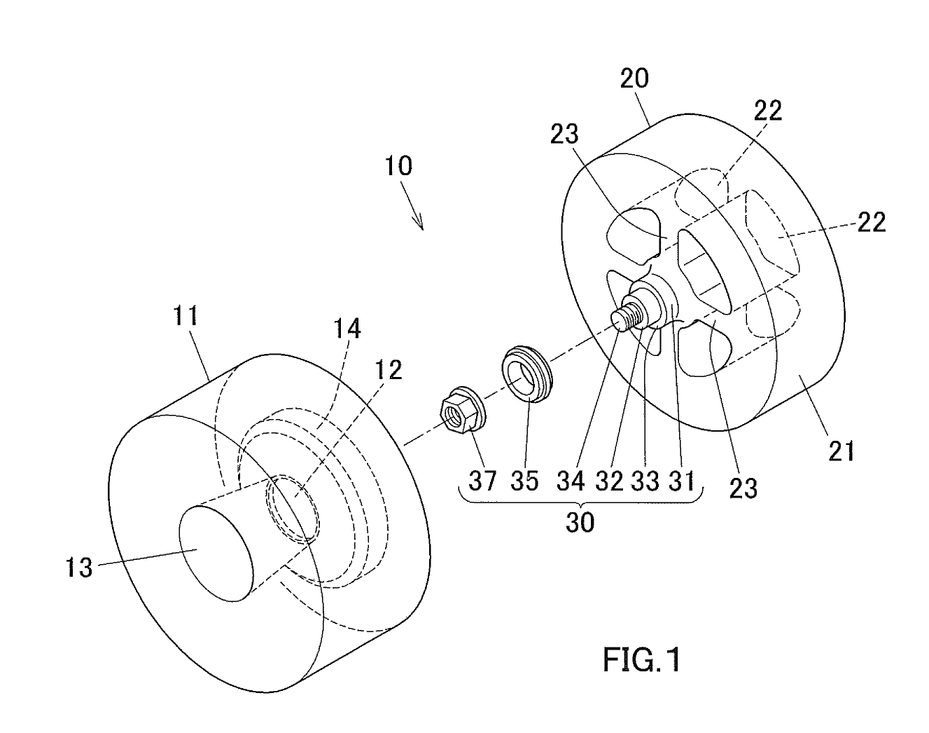

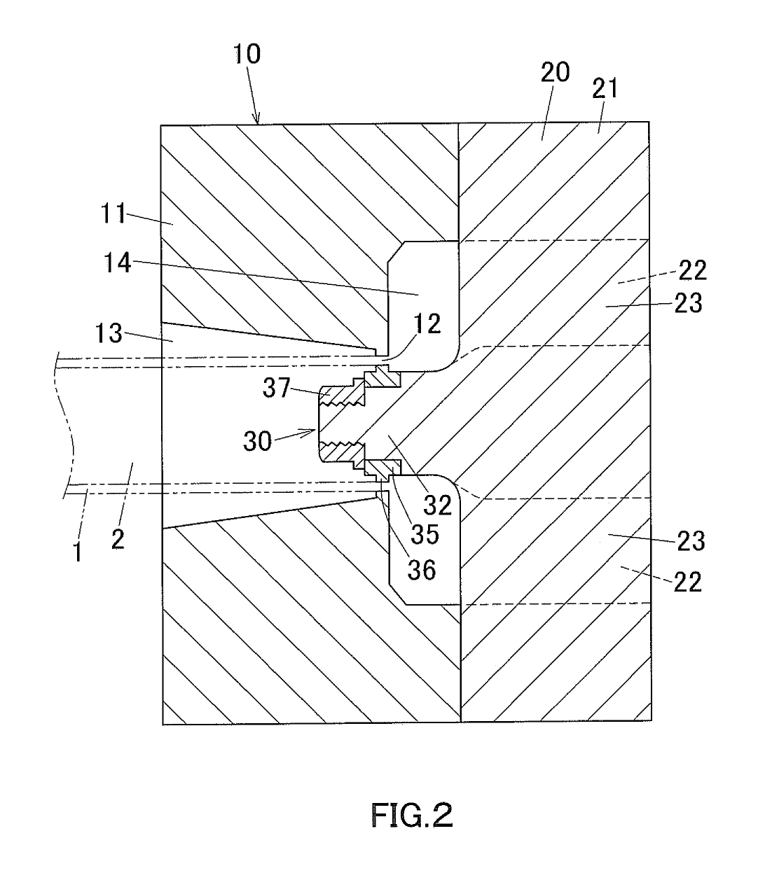

The porthole die 10 shown in FIGS. 1 and 2 is formed by assembling a female die 11 forming an outer circumferential surface of a hollow extruded material 1 and a male die 20 forming an inner circumferential surface of the hollow extruded material 1, and the male die 20 is an extrusion die according to one embodiment of the present invention.

The female die 11 includes a bearing hole 12 at the center portion thereof, a relief hole 13 formed on the downstream side of the bearing hole 12, and a welding concave portion 14 formed on the upstream side of the bearing hole 12.

The male die 20 has a mandrel 30 protruded toward the downstream side from the center of the die base 21, and a plurality of portholes 22 arranged around the mandrel 30 so as to penetrate the die base in the extrusion direction. Between the adjacent portholes 22 and 22, a leg portion 23 supporting a basal end portion 31 of the mandrel 30 protruding toward the downstream side is formed.

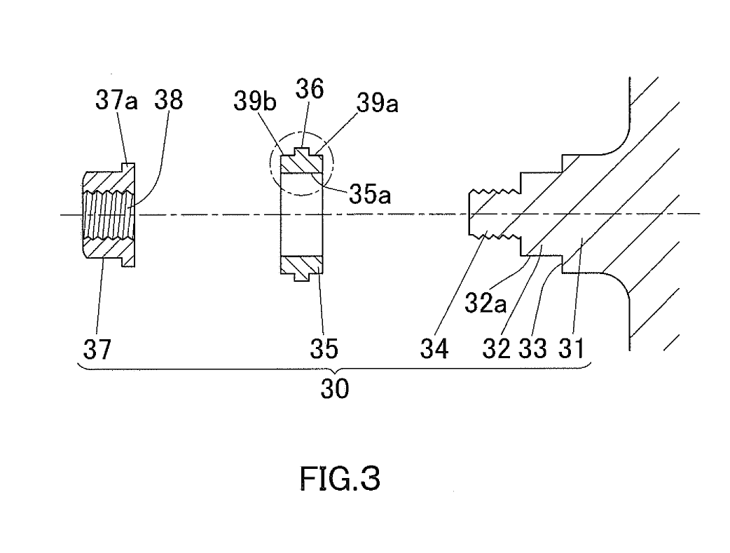

As shown in FIG. 3, in the mandrel 30, a spindle 32 with a small diameter is integrally formed on the tip end side of the basal end portion 31, and a stepped portion 33 is formed between the basal end portion 31 and the spindle 32 due to the difference in diameter. On the tip end side of the spindle 32, a bolt portion 34 which is smaller in diameter and has a spiral shaped thread groove on the outer circumferential surface is integrally formed. The basal end portion 31, the spindle 32, and the bolt portion 34 are formed coaxially. The mandrel ring 35 is a ring-shaped body in which a bearing portion 36 configured to form an inner circumferential surface of an extruded material 1 is provided in a protruding manner. The nut 37 is a restraining member of the present invention, and has a screw hole 38 to be screwed by the thread groove of the bolt portion 34. Therefore, when the mandrel ring 35 is outwardly arranged around the spindle 32 and brought into contact with the stepped portion 33 and then the screw hole 38 of the nut 37 is screwed on the bolt portion 34, the mandrel ring 35 is pinched by and between the stepped portion 33 and the nut 37, and arranged to a predetermined position in the extrusion axial direction. The characteristics and dimensions of the materials of the spindle 32 and the mandrel ring 35 will be explained later.

When the female die 11 and the male die 20 are assembled, the bearing portion 36 of the mandrel ring 35 is arranged in the bearing hole 12 of the female die 11 to thereby form an annular forming gap (no symbol) therebetween, so that a portion of the welding concave portion 14 of the female die 11 is blocked with an end surface of the male die 20 and forms a welding chamber that communicates with the portholes 22. Thus, extruding material flowed into each porthole 22 will join in the welding chamber, and will be extruded through the forming gap as an extruded material 1 having a hollow portion 2.

(Shape of the Mandrel)

In the mandrel of the present invention, the shape of the outer circumferential surface of the spindle and the inner circumferential surface of the mandrel ring can be arbitrarily set as long as, in a state in which the mandrel ring is outwardly arranged around the spindle, there is a gap between them at a normal temperature, and the gap disappears at least a part of the mandrel in the axial direction and they are brought into contact with each other at die temperature at the time of extrusion. That is, the shape of the mandrel of the present invention meets the following conditions (1) and (2):

(1) There is a gap which allows the outward arrangement of the mandrel ring around the spindle at a normal temperature, and

(2) The gap disappears at least a part of the mandrel in the axial direction so that the spindle and the mandrel ring are brought into contact with each other at a die temperature at the time of extrusion.

The “die temperature at the time of extrusion” in the present invention denotes a predetermined temperature to which the spindle 32 and the mandrel ring 35 reach at the time of high temperature extrusion.

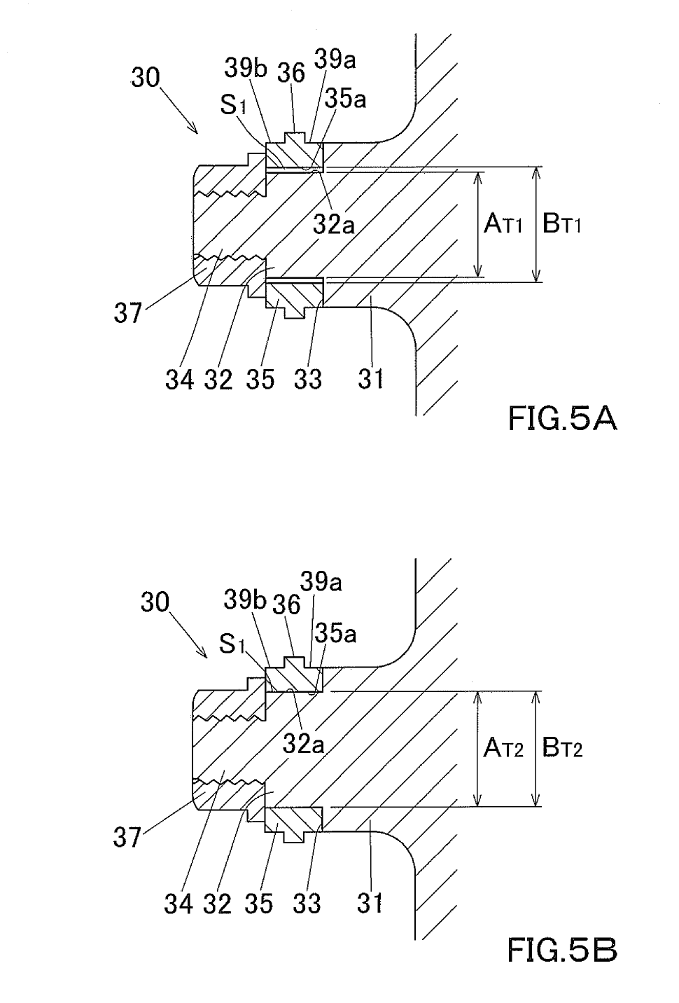

FIGS. 3 and 5A are cross-sectional views showing principal portions of the mandrel 30 of this embodiment at a normal temperature (T₁). The mandrel 30 constitutes a part of the male die 20 of the extruding die 10 shown in FIGS. 1 and 2.

In the mandrel 30, the outer circumferential surface 32a of the spindle 32 and the inner circumferential surface 35a of the mandrel ring 35 are formed in parallel with the axis of the mandrel 30, and the outer diameter (A_{T1}) of the spindle 32 and the inner diameter (B_{T1}) of the mandrel ring 35 are constant in the axial direction. When the mandrel ring 35 is outwardly arranged around the spindle 32, there exists a constant gap (S₁) parallel to the axis between them.

In the present invention, “there exists a gap S₁” between the spindle 32 and the mandrel ring 35 does not means whether or not there exists a contact between the spindle 32 and the mandrel ring 35, but means that the outer diameter A_{T1} of the spindle and the inner diameter B_{T1} of the mandrel ring at a normal temperature T₁ satisfies the relationship of “B_{T1}>A_{T1}”, and that there exists a clearance between both the members. Also, the size of the gap S1 at a normal temperature T₁ is shown by the difference (B_{T1}−A_{T1}) between the inner diameter B_{T1} of the mandrel ring and the outer diameter A_{T1} of the spindle 32.

Please note that FIG. 5A shows the state in which the distance between the inner circumferential surface 35a of the mandrel ring 35 and the outer circumferential surface 32a of the spindle 32 are constant also in the circumferential direction. However, at a normal temperature T₁, since the mandrel ring 35 and the spindle 32 are not aligned coaxially, the distance between these members is not always constant in the circumferential direction. For example, when assembling in a position in which the axis of the mandrel 30 is arranged horizontally, as shown in FIG. 5C, the upper portion of the inner circumferential surface 35a of the mandrel ring 35 comes into contact with the upper portion of the outer circumferential surface 32a of the spindle 32, i.e., the distance between them is zero, and the distance increases as it approaches along the circumferential direction toward the lower side, and the distance becomes maximum at the lower portion. Also, in some cases, since the mandrel ring 35 is tightened by the nut 37 in a temporally secured state, the members are not in contact with each other around the entire circumference, but the distance is uneven. Therefore, “there exists a gap” in the present invention does not mean whether or not the mandrel ring 35 and the spindle 32 are in contact with each other, but means that the outer diameter A_{T1} of the spindle 32 and the inner diameter B_{T1} of the mandrel ring 35 at a normal temperature T₁ satisfy the relationship of “B_{T1}>A_{T1}” and that there exist a clearance between both the members. Also, even in cases where the mandrel ring 35 and the spindle 32 satisfy either one of the aforementioned positional relationships, the size of the gap S1 is shown by the difference (B_{T1}−A_{T1}) between the inner diameter B_{T1} of the mandrel ring 35 and the outer diameter A_{T1} of the spindle 32.

Please also note that the present invention does not always require that the outer circumferential surface of the spindle and the inner circumferential surface of the mandrel ring are in parallel with the axis of the mandrel, and covers a mandrel in which either one or both of the outer circumferential surface of the spindle and the inner circumferential surface of the mandrel ring are formed into a tapered surface inclined with respect to the axis and a mandrel in which a part of the inner surface and outer surface in the axial direction is formed into a tapered surface. Therefore, the gap between the members may change in the axial direction, and the gap S₁ of the present invention means a gap at a portion where the difference (E_{T1}−A_{T1}) of the inner diameter B_{T1} of the mandrel ring and the outer diameter A_{T1} of the spindle becomes the smallest in the axial direction.

In the mandrel 30, a solid spindle 32 is employed for the purpose of securing strength, but a spindle having a hollow portion, such as, e.g., a communication passage for a cooling medium, can be used.

For the mandrel 30, in assembling the spindle 32 and the mandrel ring 35 at a normal temperature T₁, the gap S₁ between these members makes it easy to outwardly arrange the mandrel ring 35 around the spindle 32. When the nut 37 is attached and tightened, tension in the extrusion direction is applied to the spindle 32, and a pulling force in the extrusion direction is applied to the mandrel ring 35.

(Material of the Mandrel)

In the present invention, the mandrel ring can be a single member made of a base material having abrasion resistant, or a member in which an alkali-resistant coating is formed on a surface of the aforementioned base material.

The mandrel ring 35 of this embodiment is constituted by a single member made of a base material. The mandrel ring in which an alkali-resistant coating is formed on the surface of the base material will be explained in detail later.

The material constituting the base material of the mandrel ring 35 is not specifically limited so long as it has excellent abrasion resistance and that the coefficient of thermal expansion a2 of the base material constituting the mandrel ring and the coefficient of thermal expansional of the material constituting the spindle 32 satisfy the relationship α1>α2. In this embodiment, the portion including the spindle 32 (hereinafter simply referred to as “spindle”) is made of a tool steel, whereas the base material of the mandrel ring 35 is made of a hard material higher in abrasion resistance than the tool steel. As the hard material, sintered hard alloy such as WC—Co, high-speed tool steel, powdered high-speed tool steel, and ceramics can be exemplified. Table 1 shows examples of the hard materials and tool steels and the coefficients of thermal expansion thereof. It is only required that the coefficients of thermal expansion of the base material of the spindle 32 and the coefficients of thermal expansion of the mandrel ring 35 satisfy the relationship of α1>α2, and therefore the materials listed in Table 1 are not limited to the applications as described in the example. For example, the present invention allows the combination of a spindle made of a powdered high-speed tool steel and a mandrel ring made of a hard metal or ceramic.

In the present invention, as the base material of the mandrel ring, a material having a coefficient of thermal expansion smaller than that of the spindle is used. Thus, the rate of expansion of the mandrel ring due to the processing heat at the time of extrusion becomes smaller, which makes it possible to obtain an extruded material with a more stable dimension. That is, in the case of a mandrel in which a mandrel ring having a small coefficient of thermal expansion is assembled to a spindle (tool steel), the diameter difference of the spindle and the mandrel ring between when extrusion is not being performed and when the processing heat is at maximum become smaller than a diameter difference of the spindle and the mandrel ring in the case of a mandrel made of a tool steel only, which makes it possible to extrude an extruded material with a constant thickness. The stabilized dimension of the extruded material results in stabilized product quality after processing. For example, in performing a drawing process after extrusion, if the extruded material has no uneven thickness and is constant in thickness, the thickness of the drawn material will also have a constant thickness. Furthermore, the constant thickness of the extruded material results in a constant length of the drawn material. In addition, the high abrasion resistance of the base material causes less generation of abrasion powder and less mixture of abrasion powder in the extruded material. A mixture of the abrasion powder of the die, which is a foreign material, in the extruded material causes surface defects of the drawn material as well as deteriorated quality of the extruded material. A less amount of mixture of the abrasion powder in the extruded material decreases surface defects on the drawn material. Consequently, an extruded material manufactured using the extrusion die of the present invention is excellent in quality as post-processing material as well as excellent in quality as extruded material.

TABLE 1

| | | Coefficient of Thermal |
|---|---|---|
| | Material | Expansion |
| Spindle | Tool Steel (SKD61) | 13 × 10⁻⁶/° C. |
| Base | Hard alloy (WC-Co) | 7 × 10⁻⁶/° C. |
| Material of | Powdered high- | 12 × 10⁻⁶/° C. |
| Mandrel | speed tool steel | |
| Ring | Al₂O₃ | 7.7 × 10⁻⁶/° C. |
| | ZrO₂ | 8 × 10⁻⁶/° C. to 11 × 10⁻⁶/° C. |
| | Si₃N₄ | 2.3 × 10⁻⁶/° C. |
| | SiC | 3.7 × 10⁻⁶/° C. |

(Fixing of Mandrel Ring in Radial Direction)

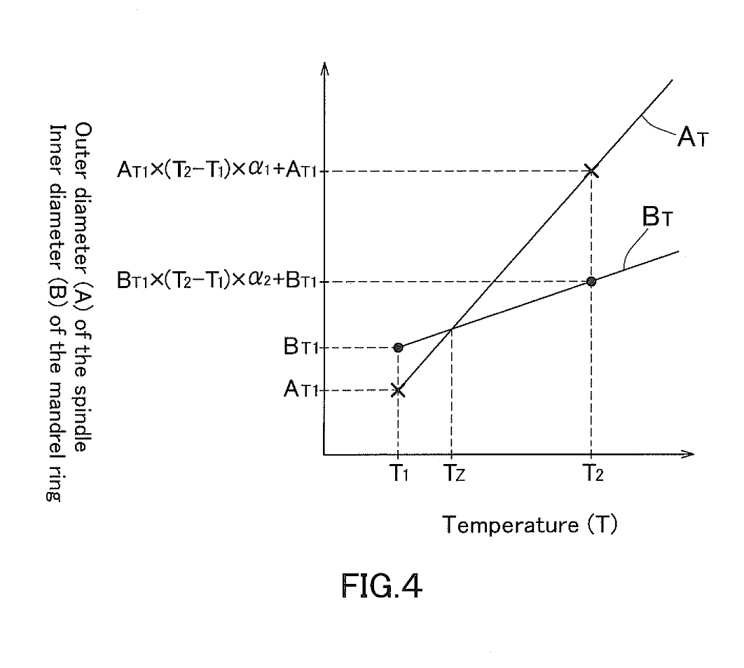

FIG. 4 shows changes of the outer diameter A of the spindle 32 and the inner diameter B of the mandrel ring 35 with respect to temperatures T.

The spindle 32 and the mandrel ring 35 increase in size due to thermal expansion (A_{T}, B_{T}). As shown in FIG. 4, at a normal temperature T₁, the inner diameter B_{T1} of the mandrel ring is larger than the outer diameter A_{T1} of the spindle, and there is a gap of (B_{T1}−A_{T1}) in actual size. As the temperature T rises, the diameters of the spindle 32 and the mandrel ring 35 increase according to the respective coefficients of thermal expansion a1 and a2. The outer diameter A_{T2} of the spindle 32 and the inner diameter B_{T2} of the mandrel ring 35 at an arbitrary temperature T₂ satisfying T₂>T₁ can be shown by the following equations I and II.

A_{T2}=A_{T1}×(T₂−T₁)×α₁+A_{T1} (I)

B_{T2}=B_{T1}×(T2−T₁)×α₂+B_{T1} (II)

where:

α₁: coefficient of thermal expansion of the material constituting the spindle;

α₂: coefficient of thermal expansion of the material constituting a base material of the mandrel ring;

T₁: normal temperature;

T₂: high temperature (>T₁);

A_{T1}: outer diameter of the spindle at the normal temperature T₁; and

B_{T1}: inner diameter (>A_{T1}) of the mandrel ring at the normal temperature T₁.

As shown in FIG. 5A, when the inner diameter B_{T1} of the mandrel ring 35 is manufactured to have a size larger than the outer diameter A_{T1} of the spindle 32 at a normal temperature T₁, the size difference thereof causes a gap S₁ between the outer circumferential surface of the spindle 32 and the inner circumferential surface of the mandrel ring 35, which enables an easily arrangement of the mandrel ring around the spindle.

As shown in FIG. 5B, as the die temperature rises, the gap S₁ reduces since the increasing degree of the outer diameter of the spindle 32 is larger than that of the inner diameter of the mandrel ring 35. When the gap S₁ disappears, the mandrel ring 35 is fixed to the spindle 32.

Since the relationship of the coefficients of thermal expansion is α1>α2, as shown in FIG. 4, with the rise in temperature, the gap S₁ disappears at the time when the outer diameter A_{TZ} of the spindle 32 and the inner diameter B_{TZ} of the mandrel ring 35 become equal at the temperature T_{Z}, resulting in that the mandrel ring 35 is immovably fixed to the spindle 32. As the temperature rises further, the outer diameter A_{T} of the spindle 32 becomes larger than the inner diameter B_{T} of the mandrel ring 35. In the temperature range T>T₁ in which the outer diameter A_{T} of the spindle 32 exceeds the inner diameter B_{T} of the mandrel ring 35, the expansion force of the spindle 32 works as a force for tightening the mandrel ring 35 from the inside, giving a pulling force in the circumferential direction to the mandrel ring 35, which results in that the mandrel ring 35 becomes even less likely to detach from the spindle 32 and is securely fixed.

(Tightening Degree of Spindle and Mandrel Ring)

At the time of extrusion, the die is heated to a predetermined temperature and becomes higher in temperature than a normal temperature T₁. Therefore, as shown in FIGS. 4 and 5B, by setting the outer diameter A_{T1} of the spindle 32 and the inner diameter B_{T1} of the mandrel ring 35 at a normal temperature T₁ so that the outer diameter A_{T2} of the spindle 32 and the inner diameter B_{T2} of the mandrel ring 35 become equal or the outer diameter A_{T2} of the spindle 32 becomes larger than the inner diameter B_{T2} of the mandrel ring 35 at the die temperature T₂ at the time of extrusion, extrusion can be executed in a state in which the mandrel ring 35 is fixed to the spindle 32. Performing the extrusion with the mandrel ring 35 fixed to the spindle 32 prevents occurrence of uneven thickness of the extruded material 1, which enables production of a high quality extruded material 1. However, if the expansion force of the spindle 32 is excessive and exceeds the limit of pulling force of the mandrel ring 35, the mandrel ring 35 will break. Therefore, taking into consideration of the coefficients of thermal expansion α1 and α2 of the materials and the die temperature T₂ at the time of extrusion, the outer diameter A_{T1} of the spindle 32 and the inner diameter B_{T1} of the mandrel ring 35 at a normal temperature T₁ are set so as to produce an appropriate pulling force of the mandrel ring at high temperatures.

Now, the tightening and loosening degree of the spindle 32 and the mandrel ring 35 at an arbitrary temperature T is defined as a tightening degree X_{T} of the following equation III, based on the ratio of the outer diameter A_{T} of the spindle 32 to the inner diameter B_{T} of the mandrel ring 35. If A_{T}<B_{T}, that is, in a state in which there exists a gap between the two members, the tightening degree X_{T} is X_{T}<0, meaning that the loosening degree increases as the tightening degree X_{T} decreases. On the other hand, if A_{T}>B_{T}, that is, in a state in which no gap exists between the members and the mandrel ring 35 is tightened by the spindle 32 from the inside, the tightening degree X_{T} is X_{T}>0, meaning that the tightening force increases as the tightening degree X_{T} increases. A_{T}=B_{T} (X_{T}=0) denotes that no gap exists between the members but no tightening force is applied.

X_{T}(%)=(A_{T}/B_{T}−1)×100 (III)

From the above equation III, the tightening degrees X_{T1} and X_{T2} of the spindle 32 and the mandrel ring 35 at a normal temperature T₁ and a high temperature T₂ (the die temperature at the time of extrusion) can be shown by the following equations IV and V.

$${X}_{T 1} ( \% ) = ( {A}_{T 1} / {B}_{T 1} - 1 ) \times 100 \\ \begin{matrix}{X}_{T2} ( \% ) = ( {A}_{T 2} / {B}_{T 2} - 1 ) \times 100 \\ = \{ \frac{[ {A}_{T 1} \times ( {T}_{2} - {T}_{1} ) \times {α}_{1} + {A}_{T 1} ]}{[ {B}_{T 1} \times ( {T}_{2} - {T}_{1} ) \times {α}_{2} + {B}_{T 1} ] - 1} \} \times 100\end{matrix} \qquad IV$$

The spindle 32 and the mandrel ring 35 are manufactured so as to meet A_{T1}<B_{T1} at a normal temperature T₁, therefore X_{T1}<0 denotes that the tightening degree X_{T1} is in a state in which a gap exists between the members but the members are loose. On the other hand, at the die temperature T₂ at the time of extrusion, the gap between the members disappears, therefore A_{T2}≧B_{T2} denotes that the tightening degree X_{T2} becomes 0 or a positive value, meaning that the tightening force is in effect. Further, X_{T2}<0 denotes a state in which there is a loose at the die temperature T₂ at the time of extrusion and the mandrel ring 35 is not fixed to the spindle 32.

As the tightening degree X_{T2} increases, the tightening force becomes stronger, resulting in secured fixing of the mandrel ring 35 in a hard-to-detach state. However, as mentioned above, an excessively large tightening force may cause breakage of the mandrel ring 35. Further, at the time of extrusion, a force in the extrusion direction is applied due to the material flow. Taking these into consideration, the tightening degree X_{T2} is preferably 0.3% or less. If the tightening degree X_{T2} is 0 or a positive value, the lower value is not limited. However, in order to attain secured fixing of the mandrel ring 35, it is preferable that the tightening degree is 0.05% or move. It is especially preferable that the tightening degree X_{T2} is 0.15% to 0.25%. It should be noted that the appropriate range of the tightening degree X_{T2} differs depending on the quality of the material of the spindle 32 and the mandrel ring 35 and the thickness of the mandrel ring 35.

Therefore, at the portion where the gap S₁ becomes minimum at a normal temperature T₁ and the tightening force becomes maximum at the die temperature T₂ at the time of extrusion, the outer diameter A_{T1} of the spindle 32 and the inner diameter B_{T1} of the mandrel ring 35 are set so that the tightening degree X_{T2} falls within the range of 0 to 0.3% at the high temperature T₂. The tightening degree at the other portions becomes a value depending on the size of the gap S₁ at a normal temperature T₁.

Also, the tightening degree X_{T1} at a normal temperature T₁ is not limited as long as it is a negative value. Since the outer diameter A_{T1} of the spindle 32 is smaller than the inner diameter B_{T1} of the mandrel ring 35, the assembling work can be performed easily. When the extrusion die is cooled to a normal temperature T₁ after extrusion, the tightening degree returns to the tightening degree X_{T1} at a normal temperature T₁, causing a loose of the extrusion die, which enables detachment of the mandrel ring 35 from the spindle 32. As a result, maintenance, such as, e.g., removal of an abraded mandrel ring and attachment of a new mandrel ring, can easily be performed.

In addition, FIGS. 5A to 5C are explanatory schematic views showing thermal expansion in the radial direction, but not showing thermal expansion in the extrusion axial direction.

(Fixing the Mandrel Ring in the Extrusion Axial Direction)

In the mandrel 30 of the above embodiment, a nut 37 having a diameter larger than the inner diameter of the mandrel ring 35 is detachably attached to the tip end of the spindle 32. The mandrel ring 35 at a high temperature T₂ is tightened and secured in the radial direction by the spindle 32, but a force toward the downstream side will be applied to the mandrel ring by the flow of the materials during extrusion. Therefore, in the mandrel 30, the nut 37 is attached to assuredly prevent the mandrel ring 35 from being pulled off and to enhance the fixing stability. Also, adding a restraining farce in the extrusion axial direction by attaching the nut 37 enables to decrease the tightening degree X_{T2} as compared with the case in which the fixing of the mandrel ring is performed only by the expansion force of the spindle 32. This prevents the risk of breakage of the mandrel ring 35 due to the increased tightening degree X_{T2}.

Further, in the mandrel 30 to which the nut 37 is attached, it is also preferable to provide a difference in size of the spindle 32 and the mandrel ring 35 in the extrusion axial direction at a normal temperature T₁ so that the nut 37 comes into contact with the mandrel ring 35 at a high temperature T₂ to attain assured restraint of the mandrel ring 35 by the nut 37.

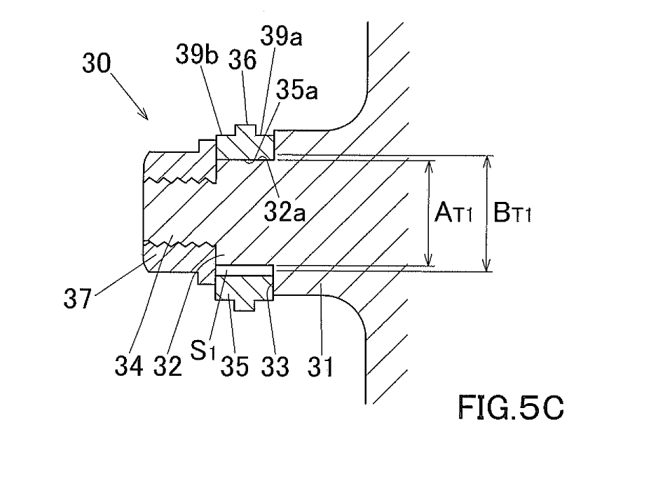

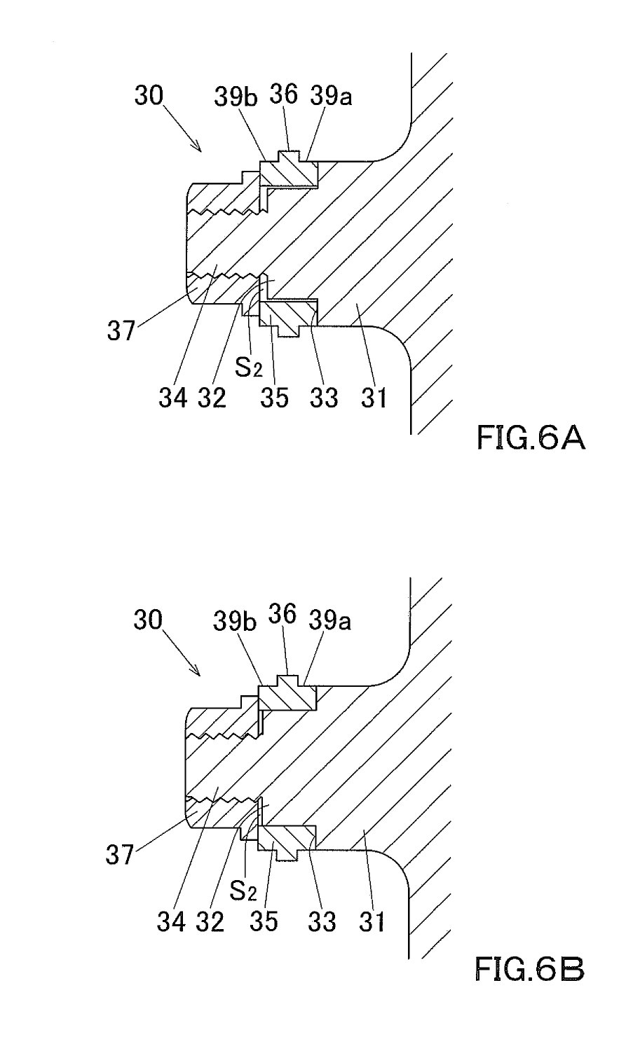

FIGS. 6A and 6B show a preferable dimensional relationship of the spindle 32 and the mandrel ring 35 in the extrusion axial direction. At a normal temperature T₁ shown in FIG. 6A, the length of the spindle 32 is shorter than the length of the mandrel ring 35, so that the nut 37 screwed to the bolt portion 34 tightens the mandrel ring 35. A pulling force corresponding to the gap S2 between the spindle 32 and the nut 37 is applied to the spindle 32, so that the mandrel ring 35 is restrained in the extrusion axis direction. FIG. 6B shows a state in which the mandrel shown in FIG. 6A is at a die temperature T₂ at the time of extrusion in which the spindle 32 and the mandrel ring 35 are expanded. The coefficient of thermal expansion α1 of the spindle 32 and the coefficient of thermal expansion α2 of the base material 61 of the mandrel ring 35 are in the relationship of α1>α2, and therefore the dimension increase amount of the spindle 32 is larger than the dimension increase amount of the mandrel ring 35, which decreases the gap S₂. The decreasing of the gap S2 results in a decreased pulling force applied to the spindle 32, which in turn causes a deteriorated tightening force to the mandrel ring 35. However, the nut 37 applies a restraining force as long as the gap S2 exists, so the mandrel ring 35 will not be displaced in the extrusion axial direction. That is, the mandrel ring 35 is restrained and fixed in both the radial direction and the extrusion axial direction. In this way, because the restraining force in the extrusion axial direction is added, even if the tightening degree X_{T2} in the radial direction is decreased, the fixing stability of the mandrel ring 35 can be maintained. This in turn can reduce the pulling force applied to the mandrel ring 35 in the circumferential direction to thereby prevent possible breakage of the mandrel ring due to the increased tightening degree X_{T2}-

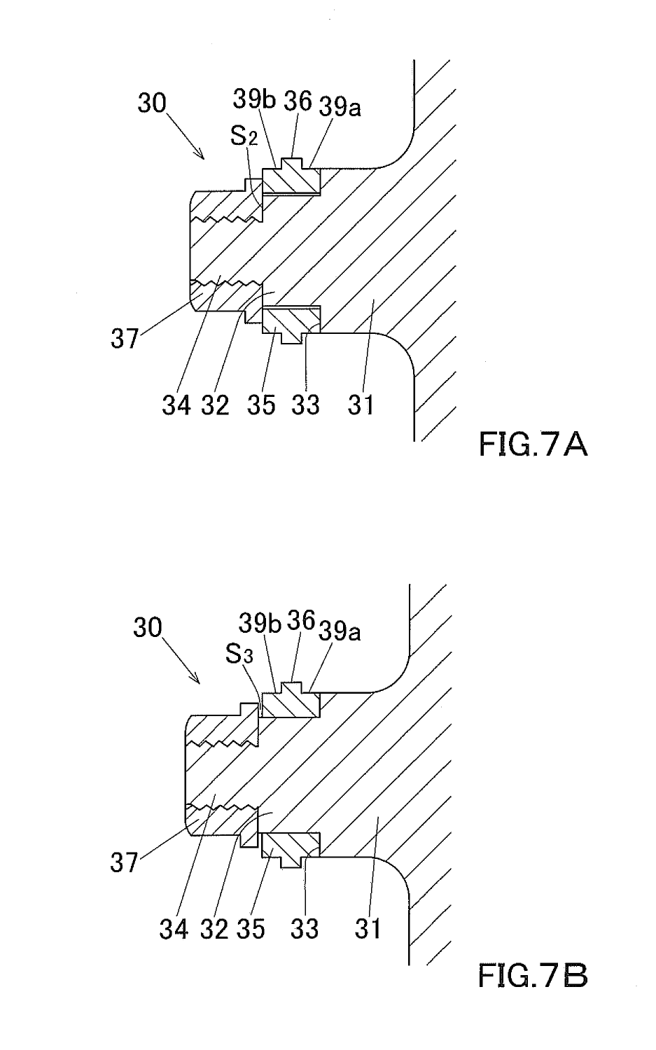

On the other hand, FIG. 7A shows a state in which the length of the spindle 32 and that of the mandrel ring 35 are equal at a normal temperature T₁ and there is no gap S2 between the spindle 32 and the nut 37. FIG. 7B shows a state in which the mandrel shown in FIG. 7A is at a die temperature T₂ at the time of extrusion in which the spindle 32 is longer than the mandrel ring 35 due to the thermal expansion and a gap S₃ is formed between the mandrel ring 35 and nut 37. In this state, the restraining of the mandrel ring 35 by the nut 37 is no longer available, resulting in deterioration of the fixing stability in the extrusion axial direction. In order to assuredly prevent the displacement of the mandrel ring 35 in this state, the tightening degree X_{T2} in the radial direction must be increased sufficiently, which increases the possibility of the breakage of the mandrel ring 35.

FIGS. 6A and 6B show an embodiment shown in which the spindle 32 is shorter than the mandrel ring 35 at a normal temperature T₁. If the difference is small and the length of the spindle 32 becomes longer than the length of the mandrel ring 35 at a die temperature T2 at the time of extrusion, the restraining force by the nut 37 does not work as in the case shown in FIG. 7B.

From the above, it is preferable that the dimensions of the spindle 32 and mandrel ring 35 in the extrusion axial direction at a normal temperature T₁ are set such that a tightening force of the nut 37 is applied to the mandrel ring 35 at a die temperature T₂ at the time of extrusion. As the die temperature rises, the mandrel ring 35 and the nut 37 loose. Therefore, in order to assuredly apply a tightening force by the nut 37 at the die temperature T₂ at the time of extrusion, it is required that the nut 37 tightens the mandrel ring 35 at least at a normal temperature T₁.

(Positioning of Mandrel Ring in the Circumferential Direction)

In the mandrel ring, the movements of the mandrel ring in the circumferential direction can be prevented by forming the cross-sectional shape of the spindle and the mandrel ring into a non-circular shape. With this, the displacement of the mandrel ring in the circumferential direction is prevented, which enhances the fixing stability, and the mandrel ring can be positioned. Especially, in cases where a hollow portion of an extruded material has a shape other than a circular shape, the positioning of the mandrel ring in the circumferential direction is required, and positioning is of great significance,

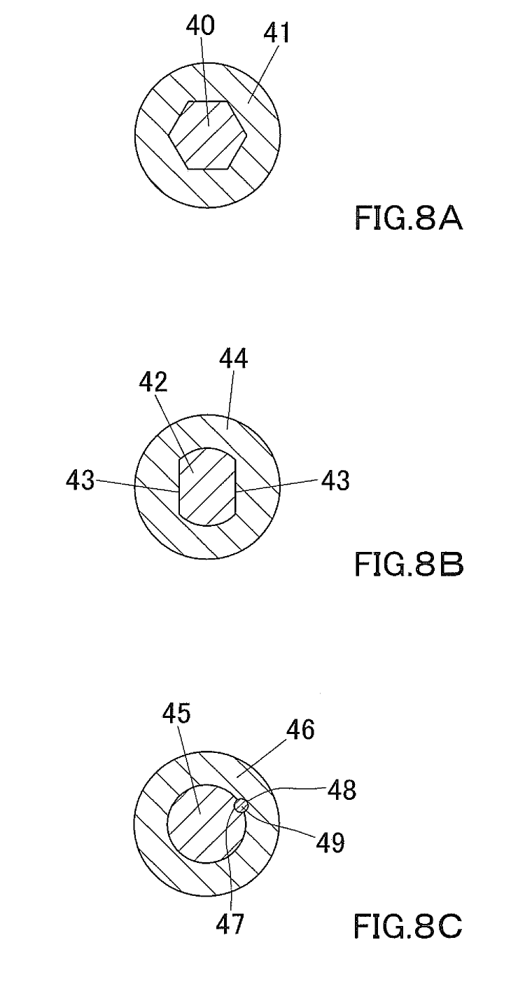

FIGS. 8A to 8C are examples of non-circular shapes. The spindle 40 shown in FIG. 8A is polygonal in cross-sectional shape (hexagonal shape in the illustrated embodiment), and a mandrel ring 41 having a polygonal hole is outwardly arranged around the spindle 40. In the example shown in FIG. 8B, the contour of the cross-section of the spindle 42 is partially formed with straight lines, and the mandrel ring 44 has a hole corresponding to the cross-sectional shape of the spindle 42. In the example shown in FIG. 8C, semicircular concave portions 47 and 48 are formed on the outer circumferential surface of the spindle 45 and the inner circumferential surface of the mandrel ring 46, and the pin 49 is inserted in the circular holes formed by aligning the concave portions 47 and 48.

(Position of the Bearing Portion of the Mandrel Ring)

The mandrel ring 35 shown in FIGS. 1 to 7B secures its strength by forming a bearing portion 36 at the center thereof in the axial direction and forming relief portions 39a and 39b on the upstream and downstream sides of the bearing portion 36. In the mandrel ring of the present invention, the position of the bearing portion is not limited as described in the above example, and the mandrel ring allows both presence and absence of relief portions. The bearing portion can be arbitrarily changed. Hereinafter, examples of the position of the bearing portion will be shown.

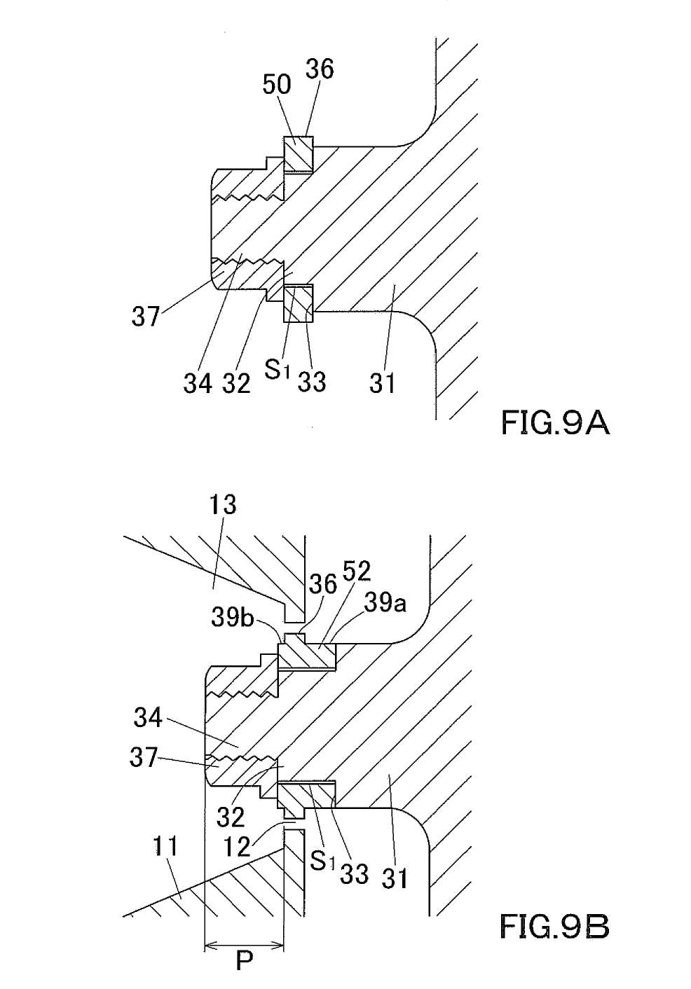

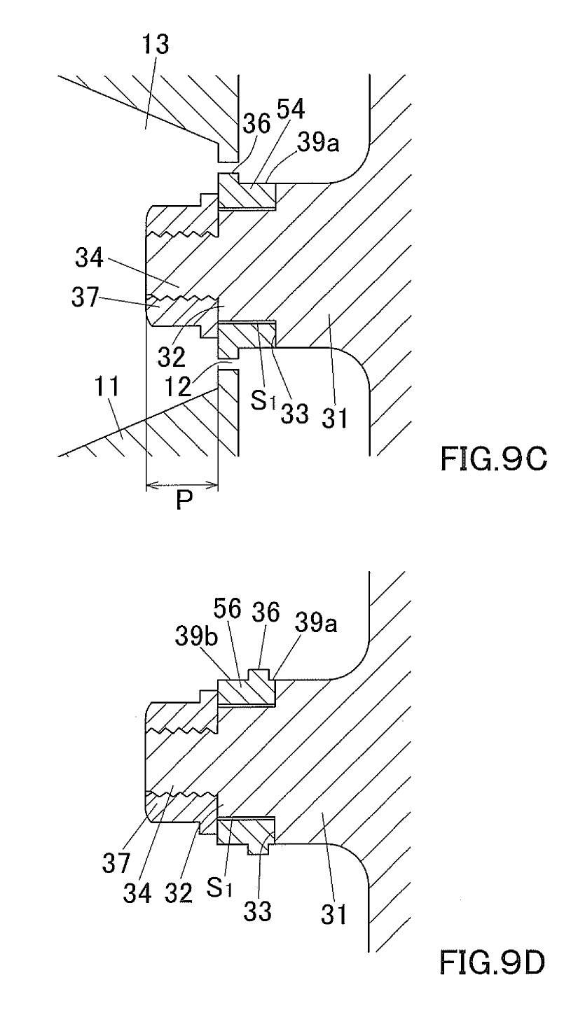

In the mandrel ring 50 shown in FIG. 9A, the entire area of the mandrel ring in the axial direction constitutes a bearing portion 36, and no relief portion exists. When strength can be secured only with the bearing portion 36, a relief portion is not always required. The mandrel ring 50 of this shape is suitable for extruding large members. The manufacturing cost of the mandrel ring can be reduced by not forming a relief portion.

The mandrel ring 52 shown in FIG. 9B has the same length in the axial direction as the mandrel ring 35 shown in FIGS. 1 to 7B, but the bearing portion 36 is arranged at a position shifted toward the downstream side than the center in the axial direction. Compared to the aforementioned mandrel ring 35, the relief portion 39a on the upstream side is longer and the relief portion 39b on the downstream side is shorter. The mandrel ring 54 shown in FIG. 9C has the same length in the axial direction as the mandrel ring 35 shown in FIGS. 1 to 7B, but no relief portion is formed on the downstream side, and a bearing portion 36 is formed on the downstream side end portion. These mandrel rings 52 and 54 have a bearing portion 36 positioned at the downstream side than the mandrel ring 35 shown in FIGS. 1 to 7B, so that the distance P from the downstream edge of the bearing portion 36 to the downstream side end face of the nut 37 or the tip of the mandrel is shorter, and the protruded amount P of the mandrel into the bearing hole 12 of the made die 11 is smaller. Decreasing the protruded amount P of the mandrel into the bearing hole 12 prevents the risk of the mandrel coming in contact with the bearing portion of the male die at the time of assembling or dismantling the die.

It should be understood that the present invention is not limited to the case in which the bearing portion is positioned at the downstream side, and allows the case in which, as shown in FIG. 9D, a mandrel ring 56 has a bearing portion 36 positioned at the upstream side.

(Surface Treatment of the Mandrel Ring)

In the present invention, as a means for maintaining the performance of the above-explained mandrel ring for a long period of time, it is recommended to protect the base material constituting the mandrel ring by forming an alkali-resistant coating on the surface of the base material.

An extruded material is adhered to a die after extrusion, and therefore the die is subjected to cleaning with a strong alkaline solution, such as, e.g., caustic soda, at the time of the die maintenance after extrusion. At that time, the base material constituting the mandrel ring as shown in Table 1 includes components contained as a binder which may be dissolved during the cleaning. For example, in the case of WC—Co, the binder Co will be selectively corroded and dissolved by a strong alkaline solution, resulting in decreased Co, which deteriorates the surface strength and results in an abraded surface. To protect the die from this phenomenon, in the present invention, a hard alkali-resistant coating having abrasion resistant is formed on the surface of the base material. The alkali resistant coating prevents the components in the base material surface portion from dissolving to thereby prevent abrasion of the base material. Further, the alkali resistance coating is hard and has abrasion resistance, and therefore abrasion of the coating itself due to the extrusion can be prevented, which enables long-term retention of the dissolve prevention effect.

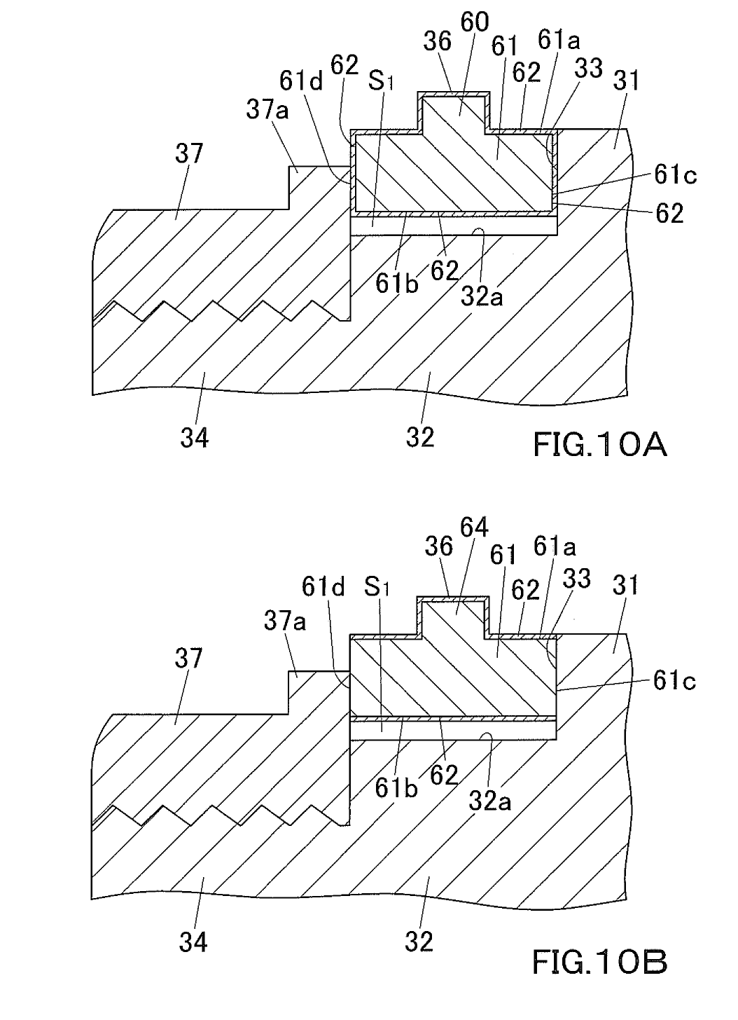

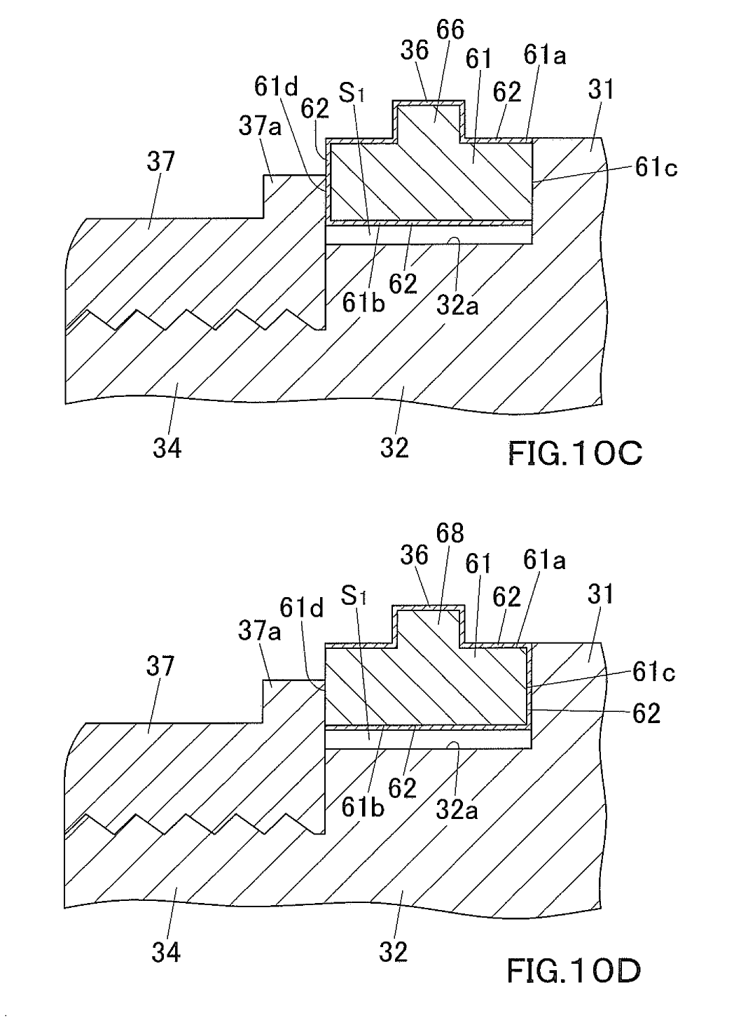

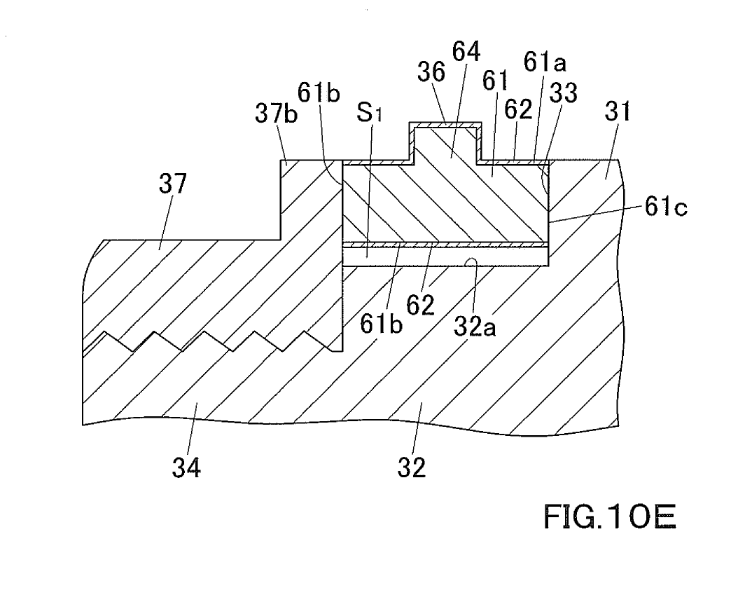

The mandrels shown in FIGS. 10A to 10D have mandrel rings 60, 64, 66, and 68 having a bearing portion 36 at the center in the axial direction in the same manner as in the mandrel 30 shown in FIGS. 1 to 7B, but differ in that the mandrel ring has an alkali-resistant coating 62 on the surface of the base material 61. Further, the mandrel shown in FIG. 10E differs in that the mandrel ring 64 has an alkali-resistant coating 62 on the surface of the base material, and the shape of the nut 37 is different. In FIGS. 10A to 10E, by allotting the same symbol to the corresponding portion of the embodiment shown in FIGS. 1 to 7B, the duplicate explanations will be omitted.

As explained above, in the present invention, utilizing the difference in coefficients of thermal expansion of the mandrel ring and the spindle, the mandrel ring is fixed to the spindle and an appropriate tightening degree X_{T2} is set at the die temperature at the time of extrusion. For this reason, the inner diameter B_{T1} of the mandrel ring is set to a dimension including the thickness of the alkali-resistant coating 62.

In the mandrel ring 60 shown in FIG. 10A, an alkali-resistant coating 62 is formed on every surfaces of the base material including the outer circumferential surface 61a, the inner circumferential surface 61b, the upstream side end face 61c, and the down stream side end face 61d.

The type of alkali-resistant coating 62 is not limited as long as the alkali-resistant coating has alkali-resistance and abrasion resistance, and coatings listed in Table 2 can be exemplified. The alkali-resistant coating 62 preferably is higher in hardness than the base material 61. For example, the HRA hardness of a hard metal (WC—Co) is around 85 (900 in HV hardness), and the preferable HV hardness of the alkali-resistant coating 62 is 900 or over, and more preferably 1,800 or over. Forming an alkali-resistant coating 62 higher in hardness than the base material 61 can further enhance the abrasion resistance of the mandrel ring 35. The coating listed in Table 2 has an HV hardness of 1,800 or over. The thickness of the alkali-resistant coating 62 is not limited, but is preferably 1 pm or more to obtain sufficient effects. The especially preferable thickness is 2 to 8 um. The alkali-resistant coating 62 can be formed by subjecting the base material 61 formed in a predetermined shape to a well-known surface treatment, such as, e.g., CVD and PVD.

Also, in the mandrel ring 60, repeating of the condition of a die temperature T₂ at the time of extrusion and the condition of a normal temperature T₁ causes repeating of expansion and compression of the base material 61. However, as long as the thickness of the alkali-resistant coating 62 falls within the aforementioned range, no breakage of the coating occurs, and therefore no dissolving of alkaline solution through the broken portion occurs.

TABLE 2

| Alkali-resistant coating | HV hardness |
|---|---|
| TiC: Titanium carbide | 3,000 |
| TiN: Titanium nitride | 2,000 |
| TiC + TiN | 2,000 to 3,000 |
| Bilayer coating of titanium | |
| carbide and titanium nitrite | |
| TiAlN: Titanium aluminum nitride | 3,000 |
| CrN: chromium nitride | 1,800 |

In the mandrel ring 60, the reason that the alkali-resistant coating 62 is formed not only on the outer circumferential surface 61a to which the extruded material adheres, but also on the inner circumferential surface 61b and side faces 61c and 61d where abrasion resistance is not required is as follows. The die temperature at the time of cleaning has been dropped to a normal temperature T₁ or a temperature lower than the die temperature T₂ at the time of extrusion, the spindle 32 and the mandrel ring 60 have been contracted and the tightening degree has been decreased, and therefore a gap S₁ has been formed between these two members. Further, cleaning solution may enter into the gap S₁ through the screwed portion of the bolt portion 34 and the nut 37 of the spindle 32, and therefore there is a risk that the inner circumferential surface 61b of the mandrel ring 60 comes into contact with the cleaning solution. If the inner circumferential surface 61b of the mandrel ring 60 is dissolved, the inner diameter of the mandrel ring will be increased, deteriorating the fixing stability of the mandrel ring 60 in the radial direction, which in turn may cause deteriorated stability of the extrusion. Therefore, the alkali-resistant coating 62 is formed on the inner circumferential surface 61b that is at risk of being in contact with cleaning solution due to the decreased tightening degree.

In cases where the mandrel ring is restrained in the axial direction from the downstream side by a restraining member such as the nut, both end faces 61c and 61d of the mandrel ring 60 are in a strong press-contact with the stepped portion 33 of the die base 31 and the nut 37, and the risk of intrusion of the cleaning solution through the mating face is very low, and therefore intrusion of the cleaning solution that would cause adverse effects on the stability of extrusion will not occur. Furthermore, as explained in the section of [FIXING THE MANDREL RING IN THE EXTRUSION AXIAL DIRECTION], the nut 37 is tightening the mandrel ring 60 strongly at a normal temperature T₁ than at a high temperature T₂ so that the mandrel ring 60 would not be loosened in the axial direction due to the difference in the coefficients of thermal expansion when the temperature is raised to the die temperature T₂ at the time of extrusion. Therefore, the risk of intrusion of the cleaning solution through end surfaces 61c and 61d of the mandrel ring 60 can be further lowered.

Consequently, considering the state at a normal temperature T₁, like the mandrel ring 64 shown in FIG. 10B, if an alkali-resistant coating 62 is formed on the outer circumferential surface 61a and the inner circumferential surface 61b of the base material 61, the possibility that the cleaning solution comes in contact with the inner circumferential surface 61b is very low even if no alkali-resistant coating 62 is formed on both end faces 61c and 61d, which does not deteriorate the fixing stability of the mandrel ring 64.

The mandrel ring 60 shown in FIG. 10A and the mandrel ring 64 shown in FIG. 10B each have a relief diameter larger than the diameter of the flange 37a of the nut 37, and therefore the outer edge portion of the downstream side end face 61d is protruded from the flange 37a. As a result, the cleaning solution comes into contact with the downstream side end face 61d. For this reason, in the mandrel ring 64 shown in FIG. 10B in which the downstream end face 61d is not covered by an alkali-resistance coating, the outer edge portion of the downstream end face 61d comes into contact with the cleaning solution, causing dissolution of the base material 61. However, even if the outer edge portion of the downstream side end face is dissolved at the time of cleaning, the fixing stability of the mandrel ring will not be deteriorated due to the dimensional change caused by the dissolution. Therefore, the alkali-resistant coating on the end face is not an essential element.

Therefore, in the mandrel having the aforementioned structure, it is sufficient that the alkali-resistant coating is formed on the outer and inner circumferential surfaces of the base material of the mandrel ring, and even if a mandrel ring in which the alkali-resistant coating is not formed on both end faces is used, the fixing stability will not be deteriorated due to cleaning. Thus, stable extrusion can be performed repeatedly.

The present invention does not exclude forming of an alkali-resistant coating on the end faces of the mandrel ring, but allows a mandrel ring 60 in which an alkali-resistant coating 62 is formed on all surfaces of the base material as shown in FIG. 10A, and a mandrel rings 66 and 68 in which an alkali-resistant coating 62 is formed on either one of the upstream side end face 61 and the downstream side end face 61d of the base material 61 as shown in FIGS. 10C and 10D.

Although the dissolution of the downstream side end face of the mandrel ring does not cause adverse effects on the fixing stability, it is apparently preferable that the outer edge portion of the downstream side end face is not dissolved from the viewpoint of extending the life of the mandrel ring. To prevent the downstream side end face of the mandrel ring from coming into contact with the cleaning solution, it is recommended that the diameter of the flange 37b of the nut 37 is increased so as to become equal to the size of the relief diameter of the mandrel ring 64 as shown in FIG. 10E so that the downstream side end face 61d of the base material 61 is covered with the flange 37b. Also, like the mandrel 60 and 66 shown in FIGS. 10A and 10C, it is also preferable to protect the base material 61 by forming an alkali-resistant coating 62 on the downstream side end face 61d of the base material 61.

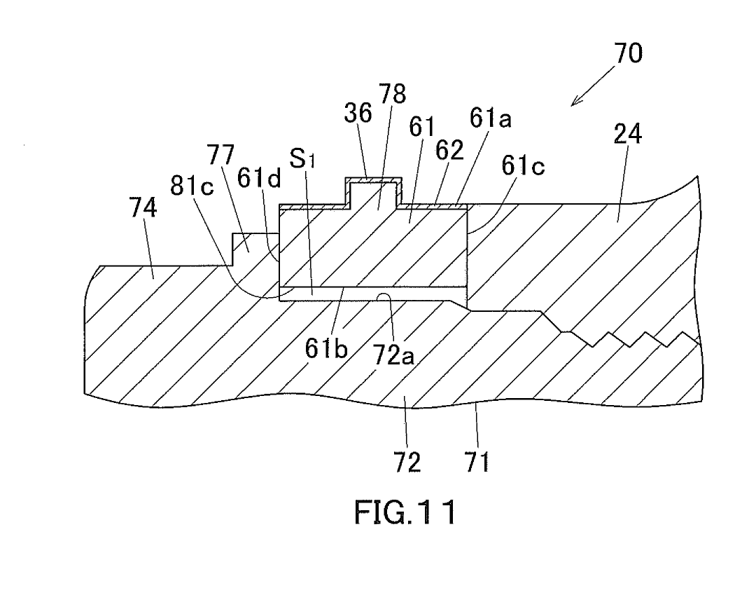

Furthermore, in cases where cleaning solution does not come into contact with an inner circumferential surface of a mandrel ring, it is possible to select an option that no alkali-resistant coating is formed on the inner circumferential surface. For example, in the case of the mandrel 70 shown in FIG. 11, the spindle 71 is detachably attached to the pedestal 24 of the base portion, and the mandrel ring 78 is attached from the upstream side of the main body portion 72 of the spindle 71. The reference numeral “72a” in this figure denotes an outer circumferential surface of the main body portion 72. In such a structure, the restraining force by the head portion 74 to the mandrel ring 78 can be adjusted by the tightening degree of the screw to the pedestal 24. Thus, there is no need to remove the head portion 74 from the main body portion 72, and the head portion 74 is continuously and integrally formed on the main body portion 72. The spindle 71 has no screw portion in the head portion 74 corresponding to the nut 37 shown in FIGS. 10A to 10D, which causes no intrusion of cleaning solution to the gap S1 from the downstream side. Also, both end faces 61c and 61d of the base material 61 are pressed strongly by the flange 77 of the pedestal 24 and the head portion 74, which causes no intrusion of cleaning solution from both end faces 61c and 61d of the base material 61 in the same manner as in the mandrel shown in FIGS. 10A to 10D. Therefore, the inner circumference of the mandrel ring 78 never comes into contact with cleaning solution. In a mandrel structure in which no cleaning solution is introduced from the tip end side (downstream side) of the spindle, as shown in FIG. 11, even in the case of using a mandrel ring 78 in which alkali-resistant coating 62 is only formed on the outer circumferential surface 61a of the base material 61 and no alkali-resistant coating 62 is formed on the upstream side end face 61c, the downstream side end face 61d, and the inner circumferential surface 61b of the mandrel ring 78, the effects by the alkali-resistant coating can be attained.

As will be apparent from the above, in a mandrel ring, if an alkali-resistant coating is formed on at least the outer circumferential surface of the base member, the mandrel ring can obtain base material protection effects by the alkali-resistant coating and the life of the mandrel ring can be extended, and for the other surfaces, forming the coating depending on the structure of the mandrel can further enhance the protection effect on the base material.

In a mandrel ring, an advantage of not forming an alkali-resistant coating on a surface of a base material resides in that the surface treatment cost for forming the alkali-resistant coating can be reduced. The CVD method and PVD method previously exemplified as a surface processing method are advantageous for the cost because there is a difference in the treatment cost between the cost for forming a coating on all surfaces and the cost for partially not forming a coating. However, there is no inconvenience even if an alkali-resistance coating is present on a surface that does not have adverse effects on the fixing stability of the mandrel ring, and therefore it is not always useless to form an alkali-resistant coating on the end faces and/or the inner circumferential surfaces of the mandrel ring to further enhance the protection effects on the base material and prepare for unexpected contacts by the cleaning solution and/or disassemble cleaning of the mandrel.

As explained above, since there exists a gap between the spindle and the mandrel ring at a normal temperature, the mandrel ring can be easily attached to and detached from the spindle, which enables easy maintenance, such as, e.g., exchanging of the mandrel ring. Also, since it is possible to re-form an alkali-resistant coating on the mandrel ring detached from the spindle, the strength of the mandrel ring can be maintained for a long period of time and its life can be extended by the protection effects on the base material by the alkali-resistant coating and re-forming of an alkali-resistant coating.

The extrusion die according to the present invention can be used not only in extruding a hollow member having a closed hollow portion, but also in extruding a semi-hollow member having a partially opened hollow portion.

The materials to be extruded using the extrusion die of the present invention are not specifically limited as long as they are metal. The metal can be exemplified by aluminum, copper, steel and alloy thereof.

### Example

### Test 1

In the Porthole Die 10 Shown in FIGS. 1 to 3, the Portion including the spindle 32 of the mandrel 30 of the male die 20 was formed by a tool steel (SKD61), and the mandrel ring 35 was formed by a hard alloy (WC—Co), the porthole die was heated to a high temperature and the fixed state of the mandrel ring 35 was examined.

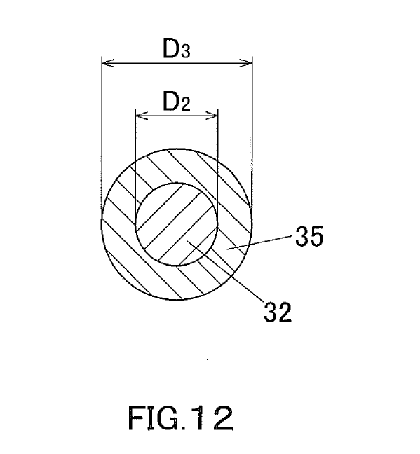

As shown in FIG. 12, three types of the spindle 32 in which the diameters D2 were 18 mm, 21 mm, and 24 mm were prepared. The mandrel rings 35 each having a bearing portion 36 with an outer diameter D₃ of 30 mm and a hole corresponding to the outer diameter D₂ of three types of spindles 32 were prepared. The spindles were assembled to the corresponding mandrel rings.

In the heating test, the normal temperature T₁ was set to 20° C., and the high temperature T2 was set to 550° C. which corresponded to the die temperature at the time of extrusion. From the coefficient of thermal expansion as listed in Table 1, the coefficient of thermal expansion α1 of the spindle 32 was 13×10⁻⁶/° C. and the coefficient of thermal expansion α2 of the mandrel ring 35 was 7×10⁻⁶/° C. In the combination of the spindles 32 having three types of diameters D₂ and the mandrel rings 35, the outer diameter A_{T1} of the spindle 32 and the inner diameter B_{T1} of the mandrel ring 35 were fine-tuned at a normal temperature T₁ so that the tightening degree X_{T2} at a high temperature T₂ fell within the seven stepped range shown in Table 2. Thus, male dies 20 of 21 (twenty one) types of mandrels 30 were prepared.

The mandrel 30 was heated to 550° C. (T₂) after outwardly arranging the mandrel ring 35 around the spindle 32 at a normal temperature T₁. Next, the fixed state of the mandrel ring 35 in a high temperature condition T₂ was observed, and evaluated based on the following evaluation standards. The evaluation results are shown in Table 3.

XX: the spindle and the mandrel ring were loose and not fixed;

◯: the mandrel ring was fixed to the spindle, and the extruded material had an uneven thickness than the case of “⊚”;

⊚: the mandrel ring was more securely fixed to the spindle than in the case of “◯,” and the uneven thickness of the extruded material was small; and

x: the mandrel ring was broken.

TABLE 3

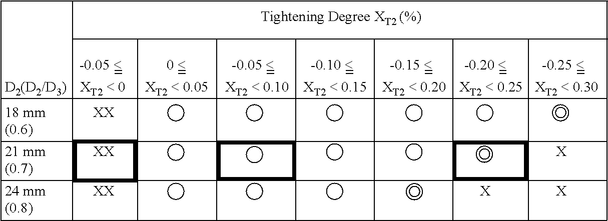

D2: The outer diameter of the spindle;
D3: Outer diameter of the mandrel ring (30 mm)
The Bold borders indicate the male die in which extrusion testing was performed.

From Table 3, it was confirmed that the mandrel rings 35 was securely fixed to the spindles 32 when the tightening degree X_{T2} became appropriate at a high temperature.

### Test 2

Among the 21 types of male dies used in TEST 1, extrusion tests were performed on the porthole dies 10 in which the male dies 11 of the three types in which the outer diameter of the spindle 32 was 21 mm and the tightening degrees X_{T2} at a high temperature were −0.05 X_{T2}≦0, 0.05≦X_{T2}<0.10, and 0.20≦X_{T2}<0.25, were combined with the female die 11. The uneven thicknesses of the extruded hollow members 1 were examined.

The extruding material was a A3003 aluminum alloy billet having a diameter of 160 mm and a length of 500 mm, and the extruded member 1 was a cylindrical tube having an outer diameter of 35 mm and an inner diameter of 30 mm. The die temperature at the time of extrusion was adjusted to 550° C., and extrusion was executed by successively extruding twelve billets for each die. Then, the uneven thickness values of the portions corresponding to the tip end portion of each billet and the rear end portion thereof on the extruded member were examined. The uneven thickness value denotes a difference between the thickest portion and the thinnest portion of the thickness of the cylindrical tube. The uneven thickness values of each porthole die 10 are shown in Table 4.

TABLE 4

| | [0.05 ≦ X_{T2} < 0.10] | | [0.20 ≦ X_{T2} < 0.25] | | [−0.05 ≦ X_{T2} < 0] | |
|---|---|---|---|---|---|---|
| | Uneven thickness | | Uneven thickness | | Uneven thickness | |
| | value (μm) | | value (μm) | | value (μm) | |
| Number | Tip end | Rear end | Tip end | Rear end | Tip end | Rear end |
| of billets | portion | portion | portion | portion | portion | portion |
| 1 | 47 | 48 | 21 | 15 | 101 | 82 |
| 2 | 44 | 57 | 29 | 20 | 95 | 80 |
| 3 | 50 | 54 | 28 | 16 | 96 | 89 |
| 4 | 59 | 55 | 25 | 26 | 105 | 92 |
| 5 | 38 | 41 | 30 | 20 | 109 | 98 |
| 6 | 48 | 46 | 25 | 15 | 101 | 105 |
| 7 | 48 | 61 | 18 | 9 | 97 | 100 |
| 8 | 54 | 52 | 15 | 18 | 94 | 97 |
| 9 | 50 | 55 | 13 | 13 | 100 | 94 |
| 10 | 43 | 54 | 14 | 14 | 95 | 103 |
| 11 | 52 | 61 | 18 | 16 | 103 | 96 |
| 12 | 58 | 61 | 14 | 11 | 93 | 99 |

From Table 4, it was confirmed that the uneven thickness can be controlled by setting the tightening degree X_{T2} to be 0% or more and the uneven thickness can be decreased by setting the tightening degree X_{T2} to be larger.

This application claims priority to Japanese Patent Application No. 2009-739 filed on Jan. 6, 2009, and the entire disclosure of which is incorporated herein by reference in its entirety.

It should be understood that the terms and expressions used herein are used for explanation and have no intention to be used to construe in a limited manner, do not eliminate any equivalents of features shown and mentioned herein, and allow various modifications falling within the claimed scope of the present invention.

### INDUSTRIAL APPLICABILITY

The extrusion die according to the present invention can be used for manufacturing various types of extruded members having a hollow portion or a semi-hollow portion.

### DESCRIPTION OF THE REFERENCE NUMERALS

1 . . . extruding material
10 . . . porthole die
11 . . . female die
20 . . . male die (extruding die)
21 . . . die base
30, 70 . . . mandrel
32 . . . spindle
32a, 72a . . . outer circumferential surface of the spindle
35, 50, 52, 54, 56, 60, 64, 66, 68, 78 . . . mandrel ring
35a . . . inner circumferential surface of the mandrel ring
36 . . . bearing portion
37 . . . nut (restraining member)
39a, 39b . . . relief portion
61 . . . base material
61a . . . outer circumferential surface of the base material
61b . . . inner circumferential surface of the base material
62 . . . alkali-resistant coating
72 . . . main body portion of the spindle (spindle)

1-15. (canceled)

16. An extrusion die comprising:
a mandrel for forming an inner surface of an extruded material,
wherein the mandrel includes a spindle and a mandrel ring outwardly arranged around the spindle,
wherein the mandrel ring is made of a material having a coefficient of thermal expansion smaller than that of a material of the spindle, and
wherein, in a state in which the mandrel ring is outwardly arranged around the spindle, the extrusion die is configured such that a gap is formed between an outer circumferential surface of the spindle and an inner circumferential surface of the mandrel ring at a normal temperature and the gap disappears at least partially in an axial direction of the mandrel to allow contact of both the outer circumferential surface of the spindle and the inner circumferential surface of the mandrel ring at a die temperature at the time of extrusion.

17. The extrusion die as recited in claim 16, wherein an outer diameter A_{T1} of the spindle and an inner diameter B_{T1} of the mandrel ring at the normal temperature T₁ are set so that a tightening degree (X_{T2}) between the spindle and the mandrel ring at the die temperature (T₂) at the time of extrusion at a portion where the gap at the normal temperature (T₁) is minimum is X_{T2}≦0%,
wherein the tightening degree (X_{T2}) is represented by an equation of:
X_{T2}={[A_{T1}×(T₂−T₁)×α₁+A_{T1}]/[B_{T1}×(T₂−T₁)×α₂+B_{T1}]−1}×100
where
α₁: coefficient of thermal expansion of the material constituting the spindle,
α₂: coefficient of thermal expansion of the material constituting the base material of the mandrel ring (α₁>α₂),
T₁: normal temperature,
T₂: die temperature (>T₁) at the time of extrusion,
A_{T1}: outer circumference diameter of the spindle at the normal temperature T₁, and
B_{T1}: inner circumference diameter (>A_{T1}) of the mandrel ring at the normal temperature T₁.

18. The extrusion die as recited in claim 16, wherein an outer diameter A_{T1} of the spindle and an inner diameter B_{T1} of the mandrel ring at the normal temperature (T₁) are set so that a tightening degree (X_{T2}) between the spindle and the mandrel ring at the die temperature (T₂) at the time of extrusion at a portion where the gap at the normal temperature (T₁) is minimum is 0 to 0.3%,
wherein the tightening degree (X_{T2}) is represented by an equation of:
X_{T2}={[A_{T1}×(T₂−T₁)×α₁+A_{T1}]/[B_{T1}×(T₂−T₁)×α₂+B_{T1}]−1}×100
where
α₁: coefficient of thermal expansion of the material constituting the spindle,
α₂: coefficient of thermal expansion of the material constituting the base material of the mandrel ring (α₁>α₂),
T₁: normal temperature,
T₂: die temperature (>T₁) at the time of extrusion,
A_{T1}: outer circumference diameter of the spindle at the normal temperature T₁, and
B_{T1}: inner circumference diameter (>A_{T1}) of the mandrel ring at the normal temperature T₁.

19. The extrusion die as recited in claim 16, wherein a restraining member configured to prevent detachment falling of the mandrel ring is detachably attached to a tip end of the spindle.

20. The extrusion die as recited in claim 16, wherein the spindle is non-circular in cross-section.

21. The extrusion die as recited in claim 16, wherein the spindle is solid.

22. The extrusion die as recited in claim 16, wherein the mandrel ring is made of hard material.

23. The extrusion die as recited in claim 22, wherein the mandrel ring is made of ceramic material.

24. The extrusion die as recited in claim 16, wherein the mandrel ring includes a relief portion on at least one of an upstream side and a downstream side of a bearing portion.

25. The extrusion die as recited in claim 24, wherein the mandrel ring includes a bearing portion formed at a downstream side than a center of the mandrel ring in an axial direction thereof.

26. The extrusion die as recited in claim 16, wherein the mandrel ring includes a bearing portion formed along an entire region of the mandrel ring in an axial direction thereof.

27. The extrusion die as recited in claim 16, wherein the mandrel ring includes a hard alkali-resistant coating formed at least on an outer circumference of a base material of the mandrel ring.

28. The extrusion die as recited in claim 27, wherein the mandrel ring includes an alkali-resistant coating formed only on an outer circumference and an inner circumference of the base material of the mandrel ring.

29. An extrusion method comprising:
preparing an extrusion die comprising a mandrel for forming an inner surface of an extruded material, wherein the mandrel includes a spindle and a mandrel ring outwardly arranged around the spindle, and the mandrel ring is made of a material having a coefficient of thermal expansion smaller than that of a material of the spindle; and
executing extrusion using the extrusion die at a die temperature (T₂) at which a tightening degree (X_{T2}) between the spindle and the mandrel ring becomes 0 to 0.3% at a portion where a gap between an outer circumferential surface of the spindle and an inner circumferential surface of the mandrel ring is minimum at a normal temperature (T₁),
wherein the tightening degree (X_{T2}) is represented by an equation of:
X_{T2}={[A_{T1}×(T₂−T₁)×α₁+A_{T1}]/[B_{T1}×(T₂−T₁)×α₂+B_{T1}]−1}×100
where
α₁: coefficient of thermal expansion of the material constituting the spindle,
α₂: coefficient of thermal expansion of the material constituting the base material of the mandrel ring (α₁>α₂),
T₁: normal temperature,
T₂: die temperature (>T₁) at the time of extrusion,
A_{T1}: outer circumference diameter of the spindle at the normal temperature T₁, and
B^{T1}: inner circumference diameter (>A_{T1}) of the mandrel ring at the normal temperature T₁.

30. The extrusion method as recited in claim 29, wherein the mandrel ring of the extrusion die is provided with a hard alkali-resistant coating at least on an outer circumferential surface of the base material, and wherein alkali cleaning is executed at the time of die maintenance after the extrusion.

31. A production method of an extruded material, comprising:
preparing an extrusion die including a mandrel for forming an inner surface of an extruded material, wherein the mandrel includes a spindle and a mandrel ring outwardly arranged around the spindle, and the mandrel ring is made of a material having a coefficient of thermal expansion smaller than that of a material of the spindle; and
executing extrusion using the extrusion die at a die temperature (T₂) at which a tightening degree (X_{T2}) between the spindle and the mandrel ring becomes 0 to 0.3% at a portion where a gap between an outer circumferential surface of the spindle and an inner circumferential surface of the mandrel ring is minimum at a normal temperature (T₁),
wherein the tightening degree (X_{T2}) is represented by an equation of:
X_{T2}={[A_{T1}×(T₂−T₁)×α₁+A_{T1}]/[B_{T1}×(T₂−T₁)×α₂+B_{T1}]−1}×100
where
α₁: coefficient of thermal expansion of the material constituting the spindle,
α₂: coefficient of thermal expansion of the material constituting the base material of the mandrel ring (α₁>α₂),
T₁: normal temperature,
T₂: die temperature (>T₁) at the time of extrusion,
A_{T1}: outer circumference diameter of the spindle at the normal temperature T₁, and
B^{T1}: inner circumference diameter (>A_{T1}) of the mandrel ring at the normal temperature T₁.
